(19) United States
(12) Patent Application Publication
(10) Pub. No.: US 2025/0005139 A1
(43) Pub. Date: Jan. 2, 2025

(54) ADAPTIVE AUTONOMOUS ROAD SIGN CLASSIFICATION WITH FORERUNNER VEHICLE UTILIZATION

(71) Applicant: International Business Machines Corporation, Armonk, NY (US)

(72) Inventors: Jana H. Jenkins, Raleigh, NC (US); Jennifer A. Mallette, Vienna, VA (US); Xin Wang, Chappaqua, NY (US); Martin G. Keen, Cary, NC (US)

(73) Assignee: International Business Machines Corporation, Armonk, NY (US)

(21) Appl. No.: 18/217,461

(22) Filed: Jun. 30, 2023

(51) Int. Cl. G06F 21/55

(52) U.S. Cl. CPC G06F 21/55

(57) ABSTRACT

A method for countering adversarial attacks on deep neural networks is disclosed. In one embodiment, such a method includes observing, by a first system, actual traffic behavior within a transportation network. The method classifies, by a deep neural network of a second system, a traffic sign for regulating traffic within the transportation network. The method determines whether a conflict exists between the actual traffic behavior and expected traffic behavior based on the traffic sign. If a conflict is deemed to exist, the method adjusts training data of the deep neural network with respect to classifying the traffic sign. In certain embodiments, the first system includes one or more forerunner vehicles and the second system is an autonomous vehicle. The one or more forerunner vehicles may be configured to travel ahead of the autonomous vehicle when navigating the transportation network. A corresponding system and computer program product are also disclosed.

### BACKGROUND

### Field of the Invention

This invention relates to deep neural networks used for autonomous vehicle training, and more specifically to techniques for combatting adversarial attacks on such systems.

### Background of the Invention

Adversarial examples are inputs intentionally designed to mislead or fool deep neural networks (DNNs). They exploit vulnerabilities in deep neural networks and can cause them to misclassify or produce incorrect outputs. Adversarial examples have become an important area of research in the field of machine learning.

Although adversarial examples can cause problems in different types of systems, they are a particular cause of concern with the deep neural networks used by autonomous vehicles. For example, adversarial examples may cause misclassification or manipulation of sensor inputs in autonomous vehicles. This can lead to incorrect decision-making, potentially resulting in dangerous situations on the road. For example, an adversarial example could make an autonomous vehicle misinterpret a stop sign as a different traffic sign, leading to a collision or other unexpected behavior.

In other cases, adversarial examples may exploit vulnerabilities in the perception systems of autonomous vehicles. Because autonomous vehicles may rely heavily on DNN-based perception systems to understand the surrounding environment using sensors like cameras, LiDAR, and radar, adversarial examples may exploit vulnerabilities of these systems, such as by misleading them to cause incorrect object detection, segmentation, or tracking. This may lead to critical failures in perceiving and reacting to the environment.

### SUMMARY

The invention has been developed in response to the present state of the art and, in particular, in response to the problems and needs in the art that have not yet been fully solved by currently available systems and methods. Accordingly, systems and methods have been developed for countering adversarial attacks on deep neural networks used by autonomous vehicles. The features and advantages of the invention will become more fully apparent from the following description and appended claims, or may be learned by practice of the invention as set forth hereinafter.

Consistent with the foregoing, a method for countering adversarial attacks on deep neural networks is disclosed. In one embodiment, such a method includes observing, by a first system, actual traffic behavior within a transportation network. The method classifies, by a deep neural network of a second system, a traffic sign for regulating traffic within the transportation network. The method determines whether a conflict exists between the actual traffic behavior and expected traffic behavior based on the traffic sign. In the event the conflict is deemed to exist, the method adjusts training data of the deep neural network with respect to classifying the traffic sign. In certain embodiments, the first system includes one or more forerunner vehicles and the second system is an autonomous vehicle. The one or more forerunner vehicles may be configured to travel ahead of the autonomous vehicle when navigating the transportation network.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level overview showing training of a deep neural network in accordance with the invention;

FIG. 3 is a high-level overview showing inference operations of a deep neural network in accordance with the invention;

FIG. 4 is a high-level block diagram showing a traffic sign classification module in accordance with the invention along with various sub-modules used to provide various features and functions;

FIG. 5A is a high-level block diagram showing functionality of a pre-configuration module in accordance with the invention;

FIG. 5B is a high-level block diagram showing functionality of a data collection module in accordance with the invention;

FIG. 6 is a high-level block diagram showing functionality of a training module in accordance with the invention;

FIG. 7 is a high-level block diagram showing functionality of a real-time data analysis module in accordance with the invention;

FIG. 8 is a high-level block diagram showing functionality of an insight generation module and communication module in accordance with the invention; and

FIG. 9 is a high-level block diagram showing functionality of a performance evaluation module and model adjustment module in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 for countering adversarial attacks on deep neural networks (i.e., collectively referred to herein as a “traffic sign classification module 150”). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

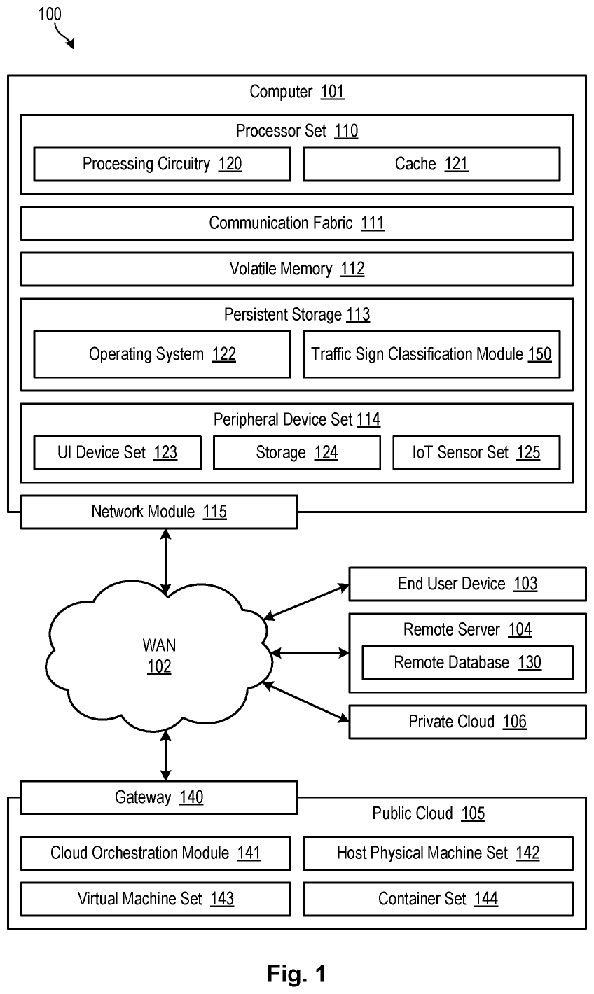

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

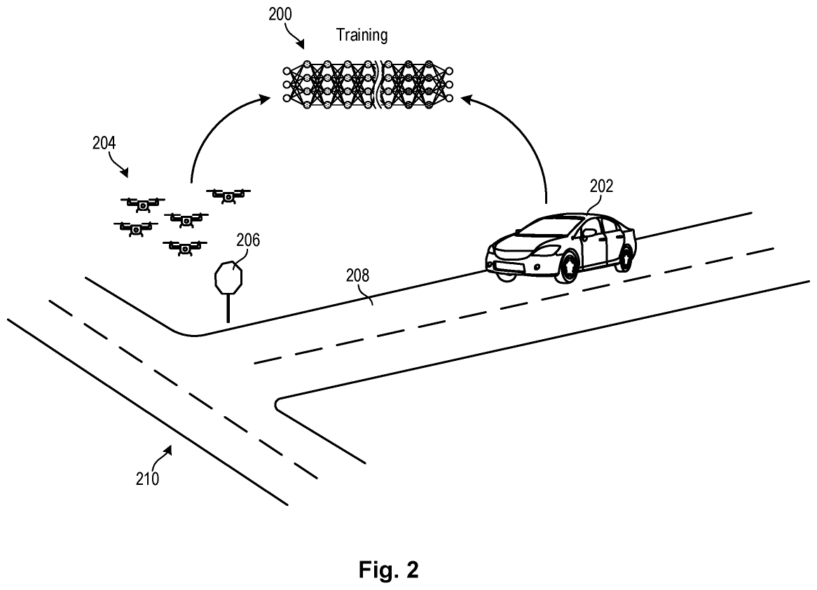

Referring to FIG. 2, as previously mentioned, adversarial examples are inputs intentionally designed to mislead or fool deep neural networks (DNNs). They exploit vulnerabilities in DNNs and can cause them to misclassify or produce incorrect outputs. Although adversarial examples can cause problems in different types of systems, they are of particular concern with deep neural networks used by autonomous vehicles. For example, adversarial examples may cause misclassification or manipulation of sensor inputs in autonomous vehicles. This can lead to incorrect decision-making, potentially resulting in dangerous situations on the road. For example, an adversarial example could make an autonomous vehicle misinterpret a stop sign as a different traffic sign, leading to a collision or other unexpected behavior.

In other cases, adversarial examples may exploit vulnerabilities in the perception systems of autonomous vehicles. Because autonomous vehicles may rely heavily on DNN-based perception systems to understand the surrounding environment using sensors such as cameras, LiDAR, and radar, adversarial examples may exploit vulnerabilities of these systems, such as by misleading them to cause incorrect object detection, segmentation, or tracking. This may lead to critical failures in perceiving and reacting to the environment. Thus, systems and methods are needed to effectively counter adversarial attacks on deep neural networks, particularly with those used by autonomous vehicles.

FIG. 2 shows one embodiment of a system that may be used to counter adversarial attacks on a deep neural network 200 used by an autonomous vehicle 202. In one embodiment, such a system includes one or more forerunner vehicles 204 (e.g., one or several unmanned aerial vehicles or ground-based vehicles) configured to travel ahead of an autonomous vehicle 202 during operation thereof on a transportation network 208 (e.g., road 208 or network of roads 208). The forerunner vehicles 204 include sensors (e.g., global positioning sensors, LIDAR sensors, thermal sensors, visual sensors, etc.) that gather data ahead of the autonomous vehicle 202. This data may include, for example, data regarding traffic signs, human driver behavior, transportation network configuration and characteristics, navigational challenges (e.g., road hazards, construction, etc.). As shown in FIG. 2, this data, as well as data gathered by the autonomous vehicle 202, may be used to train a deep neural network 200.

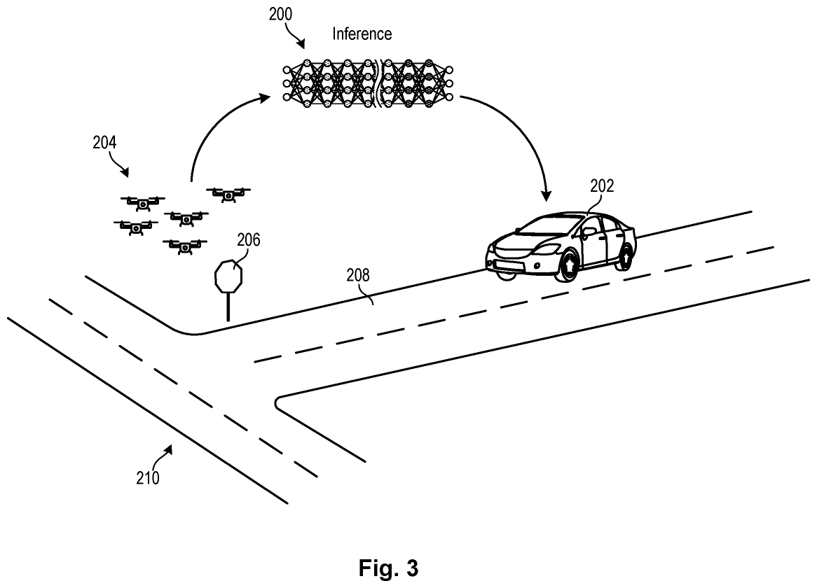

As shown in FIG. 3, once trained, the deep neural network 200 may be utilized by the autonomous vehicle 202 to perform inference operations, such as classify traffic signs 206 in real time that it encounters on the transportation network 208. More specifically, the deep neural network 200 may assist the autonomous vehicle 202 in determining whether the behavior of human drivers on the transportation network 208 is consistent with behavior that would be expected (e.g., stop, yield, merge, turn, proceed, exit, slow down, speed up, etc.) based on traffic signs 206 or other characteristics of the transportation network 208 in order to determine if the autonomous vehicle 202 is correctly classifying the traffic signs 206. In this way, the deep neural network 200 may assist the autonomous vehicle 202 in countering adversarial attacks that may cause or attempt to cause misclassification of traffic signs 206.

In order to provide the functionality described above, a traffic sign classification module 150 and various sub-modules may be provided. The traffic sign classification module 150 and associated sub-modules may be implemented in hardware, software, firmware, or combinations thereof. The traffic sign classification module 150 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules.

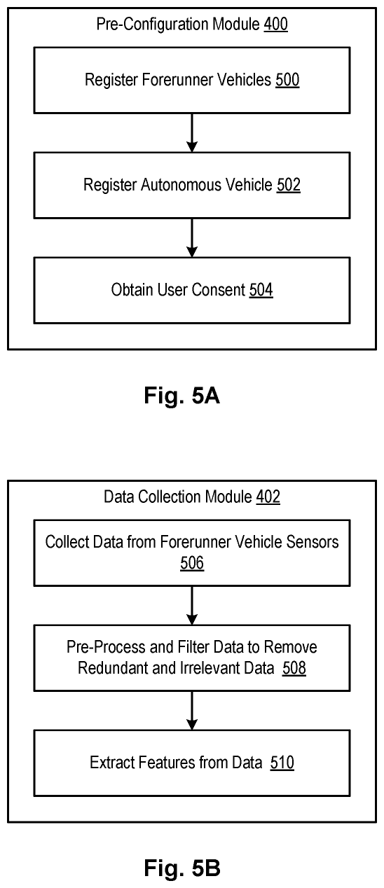

As shown, the traffic sign classification module 150 may include one or more of a pre-configuration module 400, data collection module 402, training module 404, real-time data analysis module 406, insight generation module 408, communication module 410, performance evaluation module 412, and model adjustment module 414. FIGS. 5 through 9 show exemplary functionality of the pre-configuration module 400, data collection module 402, training module 404, real-time data analysis module 406, insight generation module 408, communication module 410, performance evaluation module 412, and model adjustment module 414, respectively.

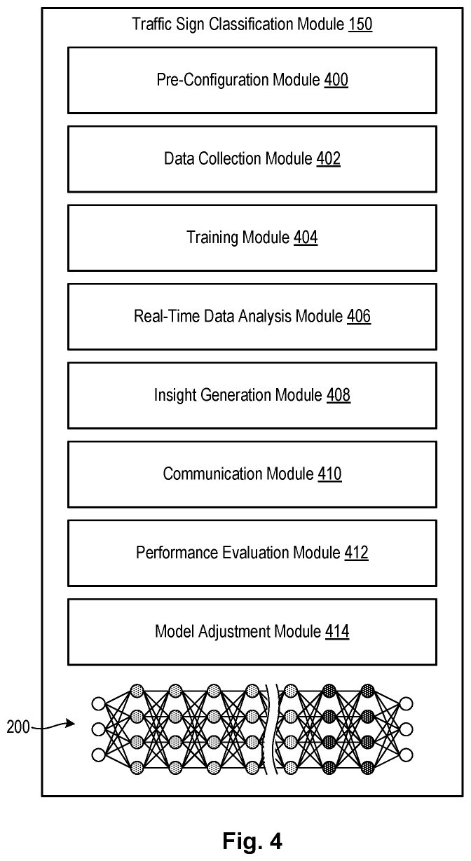

Referring to FIG. 5A, while continuing to refer generally to FIG. 4, the pre-configuration module 400 may be configured to register vehicles involved in the disclosed systems and methods. This may include registering 500 forerunner vehicles 204 involved in gathering data, as well as registering 502 the autonomous vehicle 202 that will benefit from the collected data. Registering 500 the forerunner vehicles 204 may include gathering details about the forerunner vehicles 204, including sensor capabilities, vehicle capabilities (e.g., speed, energy efficiency, etc.), vehicle communication protocols, and other relevant data. Registering the forerunner vehicles 204 may be important particularly in embodiments where the forerunner vehicles 204 include a swarm of unmanned aerial vehicles (e.g., a group of unmanned aerial vehicles configured to work together in a coordinated manner). Similarly, registering 502 the autonomous vehicle 202 may include gathering details about the autonomous vehicle 202, including sensor capabilities, vehicle capability, vehicle communication protocols, and other relevant data. The pre-configuration module 400 may also be configured to obtain 504 user consent to use the forerunner vehicles 204 in performing the disclosed functions, as well as satisfy any other relevant legal requirements.

Referring to FIG. 5B, while continuing to refer generally to FIG. 4, the data collection module 402 may be configured to collect 506 data from sensors of the forerunner vehicles 204. In certain embodiments, the data collection module 402 may pre-process 508 and filter 508 the data to remove redundant and/or irrelevant data. The data collection module 402 may be further configured to extract 510 features from the collected data, such as the location and speed of the autonomous vehicle 202, the movement and speed of surrounding vehicles, information about traffic signs 206, characteristics of the transportation network 208, navigational obstructions (e.g., road hazards, construction projects, etc.), and the like.

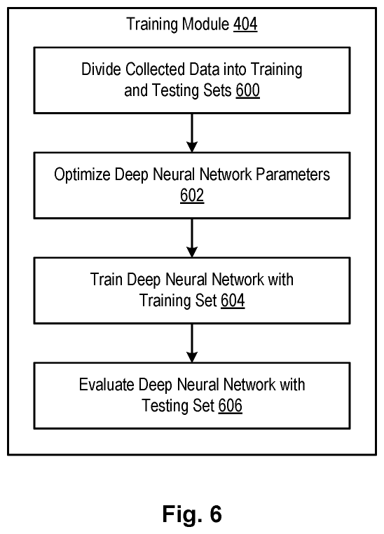

Referring to FIG. 6, while continuing to refer generally to FIG. 4, the training module 404, by contrast, may be used to train the deep neural network 200. This may include dividing 600 data collected from the forerunner vehicles 204 and/or autonomous vehicle 202 into training and testing sets. The training module 404 may then optimize 602 parameters of the deep neural network 200 using one or more of manual tuning and hyperparameter optimization. These parameters may include, for example, the learning rate of the deep neural network 200, the number of layers in the deep neural network 200, the number of neurons in each layer, the activation functions that are used, and the like. The training module 404 may then train 604 the deep neural network 200 with the training set. This may be an iterative process that adjusts parameters (e.g., weights, biases, etc.) of the deep neural network 200 based on input data and expected outputs from the training set to minimize a predefined loss function. The performance of the deep neural network 200 may then be evaluated 606 with the testing set to enable further tuning and optimization of the deep neural network 200.

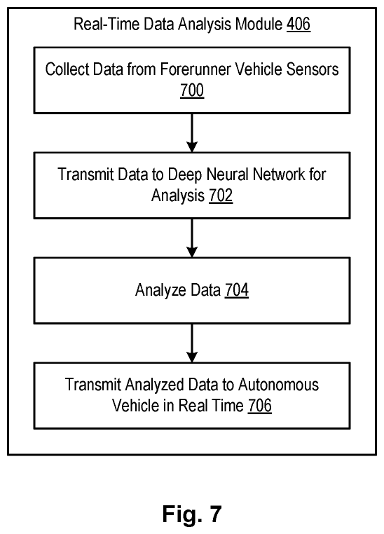

Referring to FIG. 7, while continuing to refer generally to FIG. 4, once the deep neural network 200 is trained, the real-time data analysis module 406 may perform inference operations using the deep neural network 200. More specifically, the real-time data analysis module 406 may collect 700 data from sensors of the forerunner vehicles 204 and transmit 702 this data to the deep neural network 200 for analysis. Using the deep neural network 200, the real-time data analysis module 406 may analyze 704 the data to determine what is being observed. For example, using data gathered from sensors of the forerunner vehicles 204, the deep neural network 200 may infer the behavior of drivers on the transportation network 208, such as whether the drivers are stopping, proceeding without stopping or yielding, changing lines, yielding to other vehicles, or the like. This information may then be transmitted to the autonomous vehicle 202. Alternatively, the deep neural network 200 that performs the analysis at step 704 is hosted by the autonomous vehicle 202.

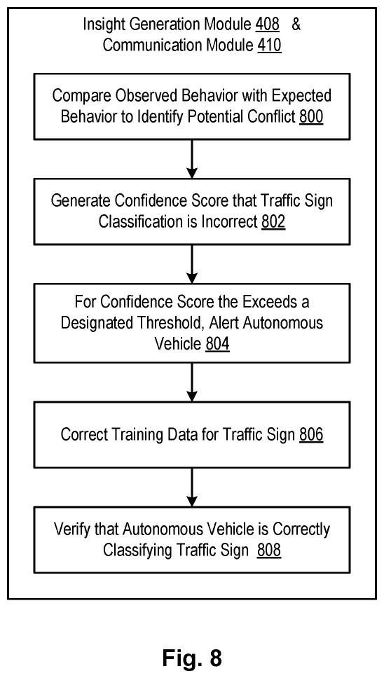

Referring to FIG. 8, while continuing to refer generally to FIG. 4, using the observed behavior received from the real-time data analysis module 406, the insight generation module 408 may compare 800 the observed behavior with expected behavior based on observed traffic signs 206 to identify any potential conflict. For example, if the autonomous vehicle 202 identifies an upcoming traffic sign 206 as a stop sign but the forerunner vehicles 204 and associated deep neural network 200 has observed that other vehicles are proceeding past the sign without stopping, this may indicate a potential conflict between observed behavior and what would be expected to occur at a stop sign. The insight generation module 408 may generate 802 a confidence score that the traffic sign classification is incorrect. The magnitude of the confidence score may correspond to the magnitude of the conflict. In the event the confidence score exceeds a designated threshold, the communication module 410 may alert 804 the autonomous vehicle 202 so that action may be taken. This may include 806 correcting training data for the traffic sign 206 and/or adjusting one or more parameters of the deep neural network 200 so that the traffic sign 206 is classified correctly. The insight generation module 408 may verify 808 that the autonomous vehicle 202 is correctly classifying the traffic sign 206 in a way that corresponds to the observed behavior.

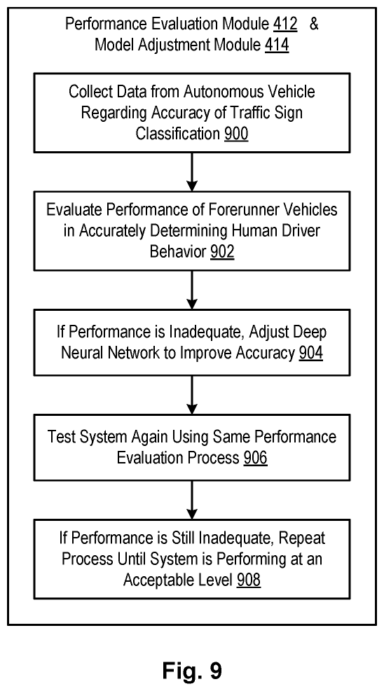

Referring to FIG. 9, while continuing to refer generally to FIG. 4, the performance evaluation module 412 may continually evaluate the autonomous vehicle's accuracy in classifying traffic signs 206. The performance evaluation module 412 may also evaluate 902 the performance of the forerunner vehicles 204 and associated deep neural network 200 in accurately determining human driver behavior. If performance is inadequate, the model adjustment module 414 may adjust 904 parameters (e.g., weights, biases, number of layers and/or nodes, activation functions used, learning rate, etc.) of the deep neural network 200. The performance evaluation module 412 may then test 906 the system again using the same evaluation process. If performance is still inadequate, the performance evaluation module 412 and model adjustment module 414 may repeat 908 the process previously described until the system is performing at an acceptable level.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for countering adversarial attacks on deep neural networks, the method comprising:
observing, by a first system, actual traffic behavior within a transportation network;
classifying, by a deep neural network of a second system, a traffic sign for regulating traffic within the transportation network;
determining whether a conflict exists between the actual traffic behavior and expected traffic behavior based on the traffic sign; and
in the event the conflict is deemed to exist, adjusting training data of the deep neural network with respect to classifying the traffic sign.

2. The method of claim 1, wherein the first system comprises at least one forerunner vehicle.

3. The method of claim 2, wherein the at least one forerunner vehicle is a swarm of unmanned aerial vehicles.

4. The method of claim 2, wherein the second system is an autonomous vehicle.

5. The method of claim 4, wherein the at least one forerunner vehicle is configured to travel ahead of the autonomous vehicle when navigating the transportation network.

6. The method of claim 1, wherein determining whether the conflict exists further comprises generating a confidence score indicating an extent to which classification of the traffic sign is incorrect.

7. The method of claim 6, further comprising, in the event the confidence score exceeds a threshold, adjusting training data of the deep neural network with respect to classifying the traffic sign.

8. A computer program product for countering adversarial attacks on deep neural networks, the computer program product comprising a computer-readable storage medium having computer-usable program code embodied therein, the computer-usable program code configured to perform the following when executed by at least one processor:
observe, by a first system, actual traffic behavior within a transportation network;
classify, by a deep neural network of a second system, a traffic sign for regulating traffic within the transportation network;
determine whether a conflict exists between the actual traffic behavior and expected traffic behavior based on the traffic sign; and
in the event the conflict is deemed to exist, adjust training data of the deep neural network with respect to classifying the traffic sign.

9. The computer program product of claim 8, wherein the first system comprises at least one forerunner vehicle.

10. The computer program product of claim 9, wherein the at least one forerunner vehicle is a swarm of unmanned aerial vehicles.

11. The computer program product of claim 9, wherein the second system is an autonomous vehicle.

12. The computer program product of claim 11, wherein the at least one forerunner vehicle is configured to travel ahead of the autonomous vehicle when navigating the transportation network.

13. The computer program product of claim 8, wherein determining whether the conflict exists further comprises generating a confidence score indicating an extent to which classification of the traffic sign is incorrect.

14. The computer program product of claim 13, wherein the computer-usable program code is further configured to, in the event the confidence score exceeds a threshold, adjust training data of the deep neural network with respect to classifying the traffic sign.

15. A system for countering adversarial attacks on deep neural networks, the system comprising:
at least one processor;
at least one memory device operably coupled to the at least one processor and storing instructions for execution on the at least one processor, the instructions causing the at least one processor to:
observe, by a first system, actual traffic behavior within a transportation network;
classify, by a deep neural network of a second system, a traffic sign for regulating traffic within the transportation network;
determine whether a conflict exists between the actual traffic behavior and expected traffic behavior based on the traffic sign; and
in the event the conflict is deemed to exist, adjust training data of the deep neural network with respect to classifying the traffic sign.

16. The system of claim 15, wherein the first system comprises at least one forerunner vehicle.

17. The system of claim 16, wherein the at least one forerunner vehicle is a swarm of unmanned aerial vehicles.

18. The system of claim 16, wherein the second system is an autonomous vehicle.

19. The system of claim 18, wherein the at least one forerunner vehicle is configured to travel ahead of the autonomous vehicle when navigating the transportation network.

20. The system of claim 15, wherein determining whether the conflict exists further comprises generating a confidence score indicating an extent to which classification of the traffic sign is incorrect.
